(19) United States
(12) Patent Application Publication
(10) Pub. No.: US 2019/0082750 A1
(43) Pub. Date: Mar. 21, 2019

(54) Jacket with openings for harness rings and method

(71) Applicants: Daniel R. Matuszak, Colorado Springs, CO (US); Dale T. Pelletier, Denver, CO (US)

(72) Inventors: Daniel R. Matuszak, Colorado Springs, CO (US); Dale T. Pelletier, Denver, CO (US)

(21) Appl. No.: 15/330,996

(22) Filed: Jan. 8, 2015

(51) Int. Cl. A41D 3/00; A41D 27/00; A41D 31/00; A62B 35/00

(52) U.S. Cl. CPC A41D 3/00; A41D 27/00; A41D 31/0022; A41D 2500/50; A41D 2300/22; A41D 2300/32; A62B 35/0006

(57) ABSTRACT

A jacket with openings for harness rings includes a jacket having sleeves and an interior side and an exterior side. There is a hole in a back of the jacket. A weather tight material extends from the hole away from an exterior side. The jacket has similar openings for other safety rings, which commonly include two roughly at the hips and one against the chest of the wearer. The weather tight material is can be made of an elastic material, which seals around the safety ring of the safety harness that provides a weather resistant opening. The jacket and weather tight material are made of fire resistant material in one case. This invention provides a jacket that protects the wearer from the elements and does not interfere with the safety harness.

### RELATED APPLICATIONS

The present invention claims priority on provisional patent application, Ser. No. 61/925,756, filed on Jan. 10, 2014, entitled “jacket with openings for harness rings” and is hereby incorporated by reference

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

Workers who work at heights are required to be wearing a safety harness. Some of these workers including welders, elevator mechanics, lineman, fork lift operator's, utility workers, and wind technicians. As well some sport climbers wear safety harnesses. While these harnesses protect the workers from falls it also exposes them to the elements. One solution has been to wear the harness over a jacket or coat, however this commonly results in an improperly adjusted harness and is uncomfortable due to bunching of the jacket. Another solution that has been tried is a jacket with a flap in the back so the dorsal D-ring can be accessed. An example is shown in the U.S. patent application Ser. No. 12/838,610. The dorsal or back D-ring is usually the one connected to the safety harness to protect from falls. The other D-rings are usually used for positioning. Unfortunately, the flap allows water, rain, wind to enter the jacket, substantially defeating the purpose of the jacket. Another solution has been to build the safety harness into the jacket. However the technology is constantly evolving with safety harnesses and generally the jacket will not outlast the safety harness that is built in. This can become cost prohibitive to purchase new jackets with a harness built in.

Thus there exists a need for a jacket that can be used with a safety harness that protects the wearer from the elements, does not interfere with the operation of the safety harness, and is not cost prohibitive.

### BRIEF SUMMARY OF INVENTION

A jacket with openings for harness rings that overcomes these and other problems includes a jacket having sleeves and an interior side and an exterior side. There is a hole in a back of the jacket. A weather tight material extends from the hole away from an exterior side. In one embodiment, the jacket has similar openings for other D-rings, which commonly include two roughly at the hips and one against the chest of the wearer. The weather tight material can be m made of an elastic material, which seals around the D-ring of the safety harness that provides a weather resistant opening. In one embodiment, the jacket and weather tight material are made of fire resistant material. This invention provides a jacket that protects the wearer from the elements and does not interfere with the safety harness. It also protects the harness from UV damage and damage from the elements, which results in extending the life of the safety harness. It also is relatively inexpensive to produce

### BRIEF DESCRIPTION OF THE SEVERAL VIEWS OF THE DRAWINGS

FIG. 1 is a front view of a man wearing a safety harness in accordance with one embodiment of the invention;

FIG. 2 is a front view of a jacket with a plurality of openings for harness rings in accordance with one embodiment of the invention;

FIG. 3 is a back view of a jacket with a plurality of openings for harness rings in accordance with one embodiment of the invention;

FIG. 4 is a cross sectional view through the opening and the weather tight material of a jacket with a plurality of openings for harness rings in accordance with one embodiment of the invention; and

FIG. 5 is a flow chart of the steps used in a method of operating a jacket with openings for harness rings in accordance with one embodiment of the invention.

### DETAILED DESCRIPTION OF THE INVENTION

The invention is directed to a jacket with openings for harness rings that includes a jacket having sleeves and an interior side and an exterior side. There is a hole in a back of the jacket. A weather tight material extends from the hole away to an exterior side. In one embodiment, the jacket has similar openings for other D-rings, which commonly include two roughly at the hips and one against the chest of the wearer. The weather tight material is made of an elastic material, which seals around the D-ring of the safety harness that provides a weather resistant opening. In one embodiment, the jacket and weather tight material are made of fire resistant material. This invention provides a jacket that protects the wearer from the elements and does not interfere with the safety harness. It also protects the harness from UV damage and damage from the elements, which results in extending the life of the safety harness.

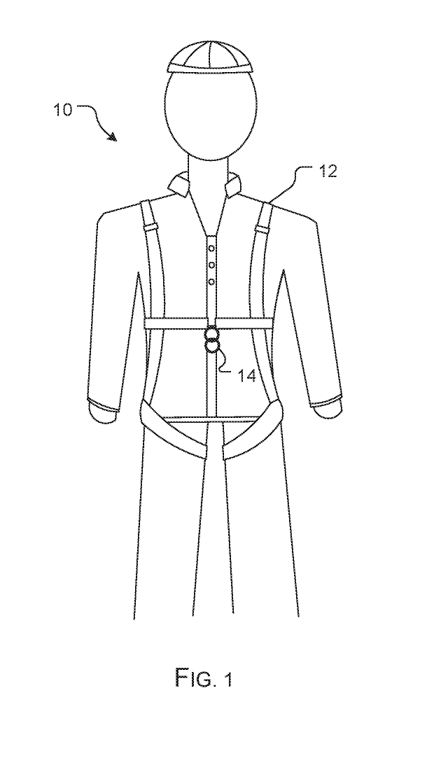

FIG. 1 is a front view of a man 10 wearing a safety harness 12 in accordance with one embodiment of the invention. There are many styles of safety harnesses and the invention is designed to work with most of them. The safety harness 12 has a number of harness or D-rings 14. Only a chest D-ring is shown in this figure but generally there are a pair of D-rings at the hips of the worker 10 and one D-ring or dorsal ring in the back of the worker 10.

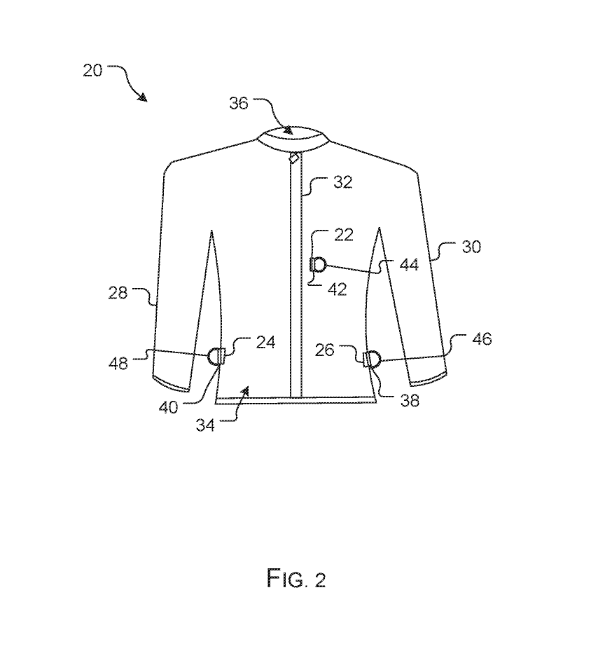

FIG. 2 is a front view of a jacket 20 with a plurality of openings 22, 24, 26 for harness rings in accordance with one embodiment of the invention. The jacket 20 has a pair of sleeves 28, 30 and zippered front 32. The jacket 20 has an exterior side 34 and an interior side 36. The plurality of openings 22, 24, 26 is a slit between the interior side 36 and the exterior side 34 of the jacket. A weather tight material 38, 40, 42 is attached to the jacket 20 and extends from the exterior side 34 of the jacket 20. In one embodiment, the weather tight material 38, 40, 42 is elastic. In another embodiment, the weather tight material 38, 40, 42 is made of neoprene. In another embodiment the weather tight material 38, 40, 42 is made of a fire resistant material. This figure shows a chest D-ring 44 extending through the opening 22 and the associated weather tight material 42. The figure also show a pair of hip D-rings 46, 48 extending through the opening 24, 26 and associated weather tight material 38, 40. The D-rings are not attached to the jacket 20 but are attached to a safety harness 12 worn by a worker. The worker is not shown in this drawing. In one embodiment, the jacket 20 is rain and water resistant. In another embodiment, the jacket 20 is designed for warmth and may also be water resistant. In yet another embodiment, the jacket is fire resistant.

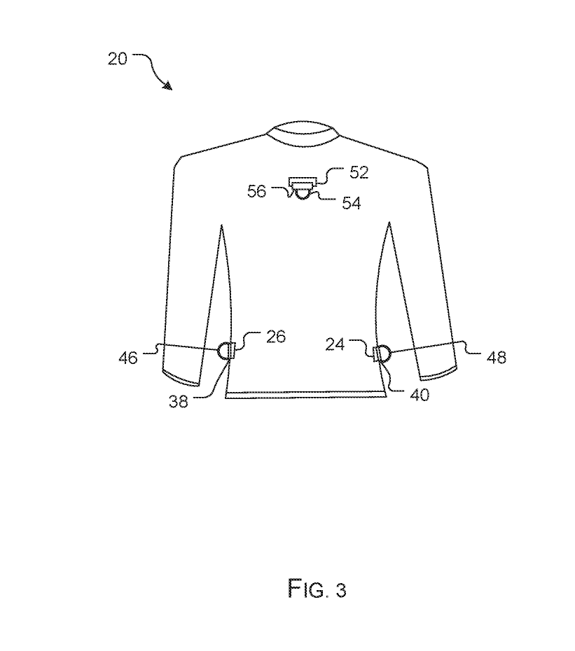

FIG. 3 is a back view of a jacket 20 with a plurality of openings 24, 26, 52 for harness rings in accordance with one embodiment of the invention. This figure shows the opening 52 for the dorsal D-ring 54 extending through the weather tight material 56. It should be noted that when this application discusses openings in the jacket, it excludes the openings for the sleeve or the zipper or other opening. The D-rings are not attached to the jacket 20 but are attached to a safety harness 12 worn by a worker. The worker is not shown in this drawing.

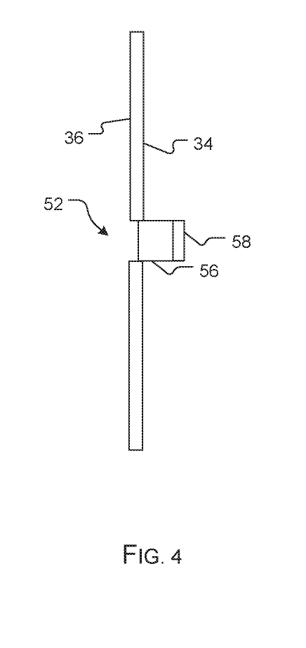

FIG. 4 is a cross sectional view through the opening and weather tight material of a jacket with a plurality of openings for harness rings in accordance with one embodiment of the invention. All the openings are constructed similarly, but this view shows the back or dorsal opening 52. The opening 52 is a slit that extends from the interior surface 36 of the jacket 20 through the exterior surface 34. The weather tight material 56 is attached around and encompasses the slit 52. In one embodiment the slit opening 56 includes a hook a loop material 58 to provide a tighter connection around the safety rings. Snaps could also be used, however neoprene is elastic enough that these are unnecessary generally.

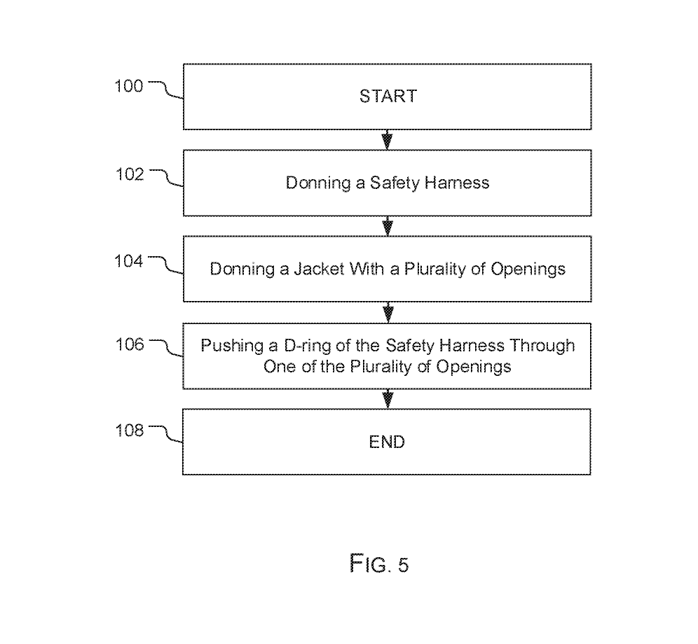

FIG. 5 is a flow chart of the steps used in a method of operating a jacket with openings for harness rings in accordance with one embodiment of the invention. The method starts, step 100, by the worker donning a safety harness at step 102. Next the worker dons the jacket with the plurality of openings at step 104. At step 106 the D-rings of the safety harness are pushed (or pulled) through the openings, which ends the process at step 108. Commonly the worker will need a co-worker to get the dorsal ring to extend through the opening.

Thus there has been described a jacket for use with a safety harness that can be used with a safety harness that protects the wearer from the elements, does not interfere with the operation of the safety harness, and is not cost prohibitive The cost of the coat is roughly the same as any similar standard jacket.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

1. A jacket with openings for harness rings, comprising:
a jacket having at least one opening extending from an exterior side of the jacket;
wherein the at least one opening is in a back of the jacket; and
a weather tight material extending around the the at least one opening to provide weather resistance around the opening.

2. The jacket of claim 1, wherein the weather tight material extends away from the exterior side of the jacket.

3. The jacket of claim 1, wherein the weather tight material is elastic.

4. The jacket of claim 1, wherein the weather tight material includes a hook and loop material.

5. The jacket of claim 1, wherein the weather tight material is a neoprene or rubber material.

6. The jacket of claim 1, further including a second opening in the side of the jacket.

7. The jacket of claim 6, further including a third opening in a front of the jacket.

8. A jacket with openings for harness rings, comprising:
a jacket having sleeves and an interior side and an exterior side;
an opening extending through the exterior side of the jacket; and
a weather tight material extending around the opening away from the exterior side.

9. The jacket of claim 8, further including a second opening in a front of the jacket, wherein the second opening has a second weather tight material.

10. The jacket of claim 9, further including a pair of opposing openings in a side of the jacket each having a side weather tight material.

11. The jacket of claim 8, wherein the weather tight material includes an elastic material.

12. The jacket of claim 8, wherein the weather tight material is neoprene material.

13. The jacket of claim 8, wherein the weather tight material is made of a fire resistant material.

14. (canceled)

15. A method of operating a jacket with openings for harness rings, comprising the steps of:
donning a safety harness;
donning a jacket with a plurality of openings; and
extending a harness ring of the safety harness through one of the plurality of openings.

16. The method of claim 15, further including the step of extending the harness ring through a weather tight material attached to the one of the plurality of openings.

17. The method of claim 16, further including the step of extending a second harness ring through a second of the plurality of openings.

18. The method of claim 16, further including the step of zipping the jacket closed.
